(19) United States
(12) Patent Application Publication
(10) Pub. No.: US 2024/0372583 A1
(43) Pub. Date: Nov. 7, 2024

(54) A Radio Transmitter with a Neural Network, and Related Methods and Computer Programs

(71) Applicant: Nokia Solutions and Networks Oy, Espoo (FI)

(72) Inventors: Janne Matti Juhani HUTTUNEN, Espoo (FI); Mikko Johannes HONKALA, Espoo (FI); Dani Johannes KORPI, Helsinki (FI)

(21) Appl. No.: 18/689,110

(22) PCT Filed: Sep. 10, 2021
(86) PCT No.: PCT/EP2021/074993

§ 371 Date: Mar. 5, 2024

(51) Int. Cl. H04B 7/0456; G06N 3/084; H04L 25/02

(52) U.S. Cl. CPC H04B 7/0456; G06N 3/084; H04L 25/0258

(57) ABSTRACT

Radio transmitter devices and related methods and computer programs are disclosed. Uplink channel information is received at a radio transmitter device. The radio transmitter device determines resource element specific precoding matrices for a downlink channel based on the received uplink channel information. The radio transmitter device generates transmit antenna specific output signals for the transmit antenna array based on the determined resource element specific precoding matrices and symbols to be transmitted. The determining of the resource element specific precoding matrices for the downlink channel based on the received uplink channel information is performed with applying a neural network to the received uplink channel information. The neural network includes at least one neural network layer executable to process the received uplink channel information to output the resource element specific precoding matrices for the downlink channel.

### TECHNICAL FIELD

The disclosure relates generally to communications and, more particularly but not exclusively, to a radio transmitter with a neural network, as well as related methods and computer programs.

### BACKGROUND

Implementing radio physical layer algorithms with neural networks is an emerging concept in the field of wireless communications. At least some of such neural networks may allow efficient inference using artificial intelligence (AI) accelerators and reduced amount of manual labour as there is no need for explicit programming of the algorithms, since the actual algorithm is learned from data. At least in some implementations machine learning (ML) may also improve overall performance as the algorithms can be adapted to changing conditions via re-training

Nowadays, base stations are typically equipped with an array consisting of multiple antennas. The radiation pattern of such an antenna array may be flexibly adjusted by tuning amplitudes and phases of each antenna signal. This makes it possible to direct a wireless signal towards receiving devices. This is referred to as beamforming.

However, at least in some situations, it may be difficult to perform accurate beamforming when a channel between uplink and downlink time slots is not static. For example, the channel may experience aging, when a user equipment or objects between the user equipment and a base station are moving. In such a case, the performance of a beamforming algorithm may be suboptimal or it may not work at all. Furthermore, when a channel estimate is inaccurate, it may be difficult to compensate for the errors in such an inaccurate channel estimate.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a radio transmitter device comprises at least one processor, at least one memory including computer program code, and a transmit antenna array comprising at least two transmit antennas. The at least one memory and the computer program code are configured to, with the at least one processor, cause the radio transmitter device to at least perform:
receiving uplink, UL, channel information;
determining resource element, RE, specific precoding matrices for a downlink, DL, channel based on the received UL channel information; and
generating transmit antenna specific output signals for the transmit antenna array based on the determined RE specific precoding matrices and symbols to be transmitted.

The determining of the RE specific precoding matrices for the DL channel based on the received UL channel information is performed by applying a neural network, NN, to the received UL channel information, the NN comprising at least one neural network layer executable to process the received UL channel information to output the RE specific precoding matrices for the DL channel.

In an example embodiment, alternatively or in addition to the above-described example embodiments, the NN comprises at least one of a convolutional neural network, a transformer neural network, or a combination thereof.

In an example embodiment, alternatively or in addition to the above-described example embodiments, the NN utilizes residual connections.

In an example embodiment, alternatively or in addition to the above-described example embodiments, at least one of the at least one neural network layer utilizes depthwise separable convolution.

In an example embodiment, alternatively or in addition to the above-described example embodiments, the at least one memory and the computer program code are further configured to, with the at least one processor, cause the radio transmitter device to perform the determining of the RE specific precoding matrices further by applying a zero-forcing, ZF, transformation or an approximation of the ZF transformation to the output of the NN.

In an example embodiment, alternatively or in addition to the above-described example embodiments, the at least one memory and the computer program code are further configured to, with the at least one processor, cause the radio transmitter device to perform the determining of the RE specific precoding matrices further based on a prediction length.

In an example embodiment, alternatively or in addition to the above-described example embodiments, the UL channel information comprises UL channel estimate information provided by a channel estimator.

In an example embodiment, alternatively or in addition to the above-described example embodiments, the UL channel information comprises UL channel estimate information provided by a radio receiver device utilizing an iterative neural network to generate the UL channel estimate information.

In an example embodiment, alternatively or in addition to the above-described example embodiments, the at least one memory and the computer program code are further configured to, with the at least one processor, cause the radio transmitter device to perform training the NN by differentiating through a simulated channel.

In an example embodiment, alternatively or in addition to the above-described example embodiments, the simulated channel is based on at least one of a statistically simulated channel, a raytraced channel, or a captured channel.

In an example embodiment, alternatively or in addition to the above-described example embodiments, the training of the NN further comprises applying a loss.

In an example embodiment, alternatively or in addition to the above-described example embodiments, the loss comprises a sum of one or more cross-entropy losses.

In an example embodiment, alternatively or in addition to the above-described example embodiments, the training of the NN further comprises optimizing the loss based on stochastic gradient descent and backpropagation.

In an example embodiment, alternatively or in addition to the above-described example embodiments, the radio transmitter device comprises a time division duplexing, TDD, capable radio transmitter device.

In an example embodiment, alternatively or in addition to the above-described example embodiments, the radio transmitter device comprises a multiple-input and multiple-output, MIMO, capable radio transmitter device.

An example embodiment of a radio transmitter device comprises means for performing:
causing the radio transmitter device to receive uplink, UL, channel information;
determining resource element, RE, specific precoding matrices for a downlink, DL, channel based on the received UL channel information; and
generating transmit antenna specific output signals for the transmit antenna array based on the determined RE specific precoding matrices and symbols to be transmitted.

The determining of the RE specific precoding matrices for the DL channel based on the received UL channel information is performed by applying a neural network, NN, to the received UL channel information, the NN comprising at least one neural network layer executable to process the received UL channel information to output the RE specific precoding matrices for the DL channel.

An example embodiment of a method comprises:
receiving, at a radio transmitter device, uplink, UL, channel information;
determining, by the radio transmitter device, resource element, RE, specific precoding matrices for a downlink, DL, channel based on the received UL channel information; and
generating, by the radio transmitter device, transmit antenna specific output signals for the transmit antenna array based on the determined RE specific precoding matrices and symbols to be transmitted,
wherein the determining of the RE specific precoding matrices for the DL channel based on the received UL channel information is performed by applying a neural network, NN, to the received UL channel information, the NN comprising at least one neural network layer executable to process the received UL channel information to output the RE specific precoding matrices for the DL channel.

In an example embodiment, alternatively or in addition to the above-described example embodiments, the NN comprises at least one of a convolutional neural network, a transformer neural network, or a combination thereof.

In an example embodiment, alternatively or in addition to the above-described example embodiments, the NN utilizes residual connections.

In an example embodiment, alternatively or in addition to the above-described example embodiments, at least one of the at least one neural network layer utilizes depthwise separable convolution.

In an example embodiment, alternatively or in addition to the above-described example embodiments, the determining of the RE specific precoding matrices is further performed by applying a zero-forcing, ZF, transformation or an approximation of the ZF transformation to the output of the NN.

In an example embodiment, alternatively or in addition to the above-described example embodiments, the determining of the RE specific precoding matrices is performed further based on a prediction length.

In an example embodiment, alternatively or in addition to the above-described example embodiments, the UL channel information comprises UL channel estimate information provided by a channel estimator.

In an example embodiment, alternatively or in addition to the above-described example embodiments, the UL channel information comprises UL channel estimate information provided by a radio receiver device utilizing an iterative neural network to generate the UL channel estimate information.

In an example embodiment, alternatively or in addition to the above-described example embodiments, the method further comprises training the NN by differentiating through a simulated channel.

In an example embodiment, alternatively or in addition to the above-described example embodiments, the simulated channel is based on at least one of a statistically simulated channel, a raytraced channel, or a captured channel.

In an example embodiment, alternatively or in addition to the above-described example embodiments, the training of the NN further comprises applying a loss.

In an example embodiment, alternatively or in addition to the above-described example embodiments, the loss comprises a sum of one or more cross-entropy losses.

In an example embodiment, alternatively or in addition to the above-described example embodiments, the training of the NN further comprises optimizing the loss based on stochastic gradient descent and backpropagation.

In an example embodiment, alternatively or in addition to the above-described example embodiments, the radio transmitter device comprises a time division duplexing, TDD, capable radio transmitter device.

In an example embodiment, alternatively or in addition to the above-described example embodiments, the radio transmitter device comprises a multiple-input and multiple-output, MIMO, capable radio transmitter device.

An example embodiment of a computer program comprises instructions for causing a radio transmitter device to perform at least the following:
receiving uplink, UL, channel information;
determining resource element, RE, specific precoding matrices for a downlink, DL, channel based on the received UL channel information; and
generating transmit antenna specific output signals for the transmit antenna array based on the determined RE specific precoding matrices and symbols to be transmitted,
wherein the determining of the RE specific precoding matrices for the DL channel based on the received UL channel information is performed by applying a neural network, NN, to the received UL channel information, the NN comprising at least one neural network layer executable to process the received UL channel information to output the RE specific precoding matrices for the DL channel.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2 shows an example embodiment of the subject matter described herein illustrating a radio transmitter device;

FIG. 3 illustrates time division duplexing shown in frequency domain;

FIG. 4A shows an example embodiment of the subject matter described herein illustrating a network node device with a radio transmitter device and a radio receiver device;

FIG. 4B shows another example embodiment of the subject matter described herein illustrating another network node device with a radio transmitter device and a radio receiver device;

FIG. 5 shows an example embodiment of the subject matter described herein illustrating a neural network applied by a radio transmitter device;

FIG. 6 shows an example embodiment of the subject matter described herein illustrating training of a neural network applied by a radio transmitter device;

FIG. 7 shows another example embodiment of the subject matter described herein illustrating a neural network applied by a radio receiver device; and

FIG. 8 shows an example embodiment of the subject matter described herein illustrating a method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

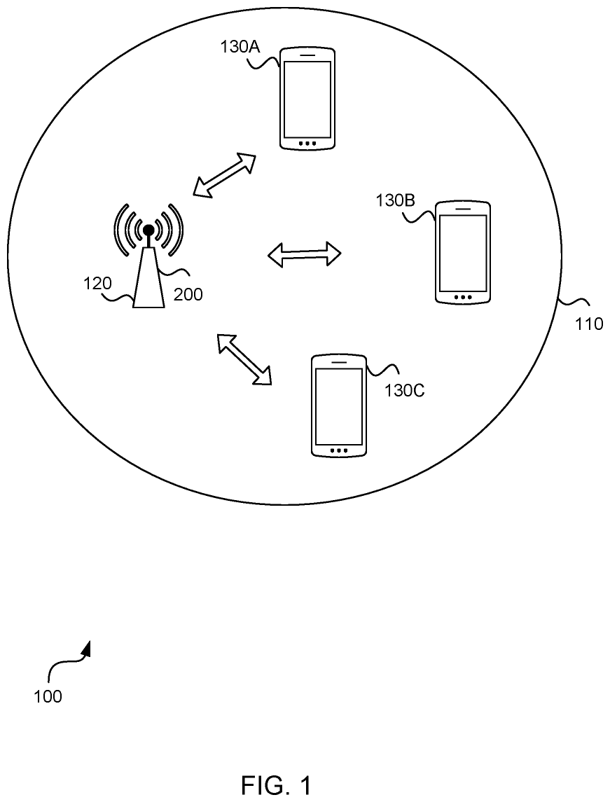

FIG. 1 illustrates an example system 100, where various embodiments of the present disclosure may be implemented. The system 100 may comprise a fifth generation (5G) new radio (NR) network 110. An example representation of the system 100 is shown depicting a client devices 130A, 130B, 130C, and a network node device 120. At least in some embodiments, the 5G NR network 110 may comprise one or more massive machine-to-machine (M2M) network(s), massive machine type communications (mMTC) network(s), internet of things (IoT) network(s), industrial internet-of-things (IIoT) network(s), enhanced mobile broadband (eMBB) network(s), ultra-reliable low-latency communication (URLLC) network(s), and/or the like. In other words, the 5G NR network 110 may be configured to serve diverse service types and/or use cases, and it may logically be seen as comprising one or more networks.

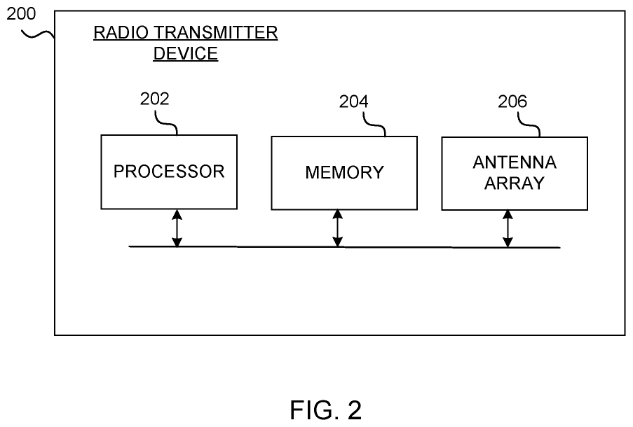

The client devices 130A, 130B, 130C may include, e.g., a mobile phone, a smartphone, a tablet computer, a smart watch, or any hand-held, portable and/or wearable device. The client devices 130A, 130B, 130C may also be referred to as a user equipment (UE). The network node device 120 may be a base station. The base station may include, e.g., a fifth-generation base station (gNB) or any such device suitable for providing an air interface for client devices to connect to a wireless network via wireless transmissions. The network node device 120 may comprise a radio transmitter device 200 of FIG. 2.

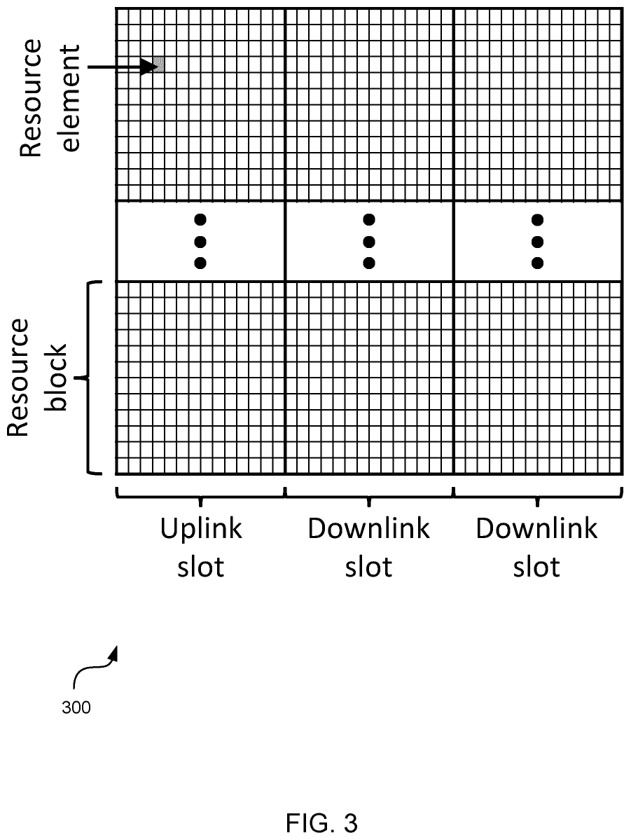

Diagram 300 of FIG. 3 illustrates time division duplexing (TDD) shown in frequency domain.

Mathematically beamforming may be expressed in frequency domain as follows. N_{R} represents the number of antennas in a base station, and N_{T} represents the number of MIMO layers (e.g., the number of UEs if each UE has only one antenna). S∈ [symbol] ^{N}^{_{T}} represents a vector of symbols (i.e., data to be transmitted to the UEs, modulated using, e.g., quadrature amplitude modulation (QAM)). The output signal to the antennas (per resource element) may be expressed as

x=Ws

In which W is a N_{R}×N_{T} complex-valued precoding matrix. As this is a complex matrix, the amplitude and phase alterations of the antenna signals are expressed by the absolute values and angles of the complex elements. The signals received by the UEs (all signals stacked to a vector y) may be written as

$$y = Hx + z = HWs + z$$

where H is a N_{T}×N_{R} (complex) matrix representing a channel, and z is a noise signal. For a perfect wireless transmission, it would be desirable that y=x+\tilde{z}, i.e., that the receivers would receive the intended signal plus white noise. One way for achieving this (at least approximatively) is to choose W such that HW becomes an identity matrix. This leads to a choice of W=H^{†} (the pseudoinverse of H, H^{†}=H^{H}(HH^{H})⁻¹, in which ( )^{H} denotes a Hermitian transpose), which is referred to as zero-forcing (ZF) beamforming. Other techniques for choosing the precoding matrix W may also be employed.

However, at least in some situations it may be difficult to obtain the channel information (H). In the disclosure, time division duplexing (TDD) may be considered in which uplink and downlink transmissions are carried out in different time slots, as illustrated in FIG. 3, but on the same frequency band. In TDD, the reciprocity of the channel may be utilized, since the channel in uplink (UL) direction (i.e., UE->BS) is equal to the channel in downlink (DL) direction (i.e., BS->UE). The matrix H is only transposed. Therefore, downlink beamforming algorithms may utilize the uplink channel estimate for H, invoking the assumption that the channel does not change significantly between uplink and downlink time slots.

As disclosed herein, the term “convolutional neural network” indicates that the network employs a mathematical operation called convolution. Convolutional networks are a type of neural networks that use convolution in place of general matrix multiplication in at least one of their layers.

Convolutional neural networks comprise multiple layers of artificial neurons. Artificial neurons are mathematical functions that calculate the weighted sum of multiple inputs, and output an activation value. The behaviour of each neuron is defined by its weights. The process of adjusting these weights is called “training” the neural network.

In other words, each neuron in a neural network computes an output value by applying a specific function to the input values received from a receptive field in a previous layer. The function that is applied to the input values is determined by a vector of weights and a bias. Learning consists of iteratively adjusting these biases and weights. The vector of weights and the bias are called filters and represent particular features of the input.

It is possible to train one machine learning model with a specific architecture, then derive another machine learning model from that using processes such as compilation, pruning, quantization or distillation. The machine learning model can be executed using any suitable apparatus, for example a CPU, GPU, ASIC, FPGA, compute-in-memory, analog, or digital, or optical apparatus. It is also possible to execute the machine learning model in an apparatus that combines features from any number of these, for instance digital-optical or analog-digital hybrids. In some examples, the weights and required computations in these systems may be programmed to correspond to the machine learning model. In some examples, the apparatus may be designed and manufactured so as to perform the task defined by the machine learning model so that the apparatus is configured to perform the task when it is manufactured without the apparatus being programmable as such.

In the following, various example embodiments will be discussed. At least some of these example embodiments may allow a machine learning (ML) based radio transmitter architecture and a training method for this architecture. A first disclosed approach allows beamforming/precoding based on neural networks in which a neural network beamformer (DeepTx) 500 may take a channel estimate from a separate channel estimator 251 as input and process it to form transmitted signal. A second disclosed approach combines a DeepRx 700 type neural network receiver 250B with a neural network beamformer 500. In this approach the DeepTx 500 may be trained together with the DeepRx 700, such that the latter learns to provide an accurate representation of the channel estimate to the former. Therefore, this approach may take advantage of the high channel estimation accuracy of the DeepRx 700, combined with a learned way to transfer data between a radio receiver device 250B and a beamforming radio transmitter device 200.

FIG. 2 is a block diagram of the radio transmitter device 200, in accordance with an example embodiment. At least in some embodiments, the radio transmitter device 200 may comprise a time division duplexing (TDD) and/or multiple-input and multiple-output (MIMO) capable radio transmitter device.

The radio transmitter device 200 comprises one or more processors 202 and one or more memories 204 that comprise computer program code. The radio transmitter device 200 further comprises a transmit antenna array 206 comprising at least two transmit antennas. The radio transmitter device 200 may be configured to transmit information to other devices. In one example, the radio transmitter device 200 may transmit signalling information and data in accordance with at least one cellular communication protocol. The radio transmitter device 200 may be configured to provide at least one wireless radio connection, such as for example a 3GPP mobile broadband connection (e.g., 5G).

Although the radio transmitter device 200 is depicted to include only one processor 202, the radio transmitter device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments, such as a neural network 500.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network chip, an artificial intelligence (AI) accelerator, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The radio transmitter device 200 may comprise any of various types of digital devices capable of transmitting radio communication in a wireless network. At least in some embodiments, the radio transmitter device 200 may be comprised in a base station, such as a fifth-generation base station (gNB) or any such device providing an air interface for client devices to connect to the wireless network via wireless transmissions.

The at least one memory 204 and the computer program code are configured to, with the at least one processor 202, cause the radio transmitter device 200 to at least perform receiving uplink (UL) channel 410 information.

The at least one memory 204 and the computer program code are further configured to, with the at least one processor 202, cause the radio transmitter device 200 to perform determining resource element (RE) specific precoding matrices for a downlink (DL) channel 420 based on the received UL channel 410 information.

The determining of the RE specific precoding matrices for the DL channel 420 based on the received UL channel 410 information is performed by applying a neural network (NN) 500 to the received UL channel 410 information. The NN 500 comprises at least one neural network layer 506 executable to process the received UL channel 410 information to output the RE specific precoding matrices for the DL channel 420. The NN 500 may comprise at least one of a convolutional neural network, a transformer neural network, or a combination thereof.

For example, the NN 500 may utilize residual connections. In at least some embodiments, at least one of the at least one neural network layer 506 may utilize depthwise separable convolution. At least in some embodiments, at least one of the at least one neural network layer 506 may comprise a deep residual learning network (ResNet) block.

The at least one memory 204 and the computer program code may be further configured to, with the at least one processor 202, cause the radio transmitter device 200 to perform the determining of the RE specific precoding matrices further by applying a zero-forcing (ZF) transformation or an approximation of the ZF transformation to the output of the NN 500.

The at least one memory 204 and the computer program code may be further configured to, with the at least one processor 202, cause the radio transmitter device 200 to perform the determining of the RE specific precoding matrices further based on a prediction length 401.

The at least one memory 204 and the computer program code are further configured to, with the at least one processor 202, cause the radio transmitter device 200 to perform generating transmit antenna specific output signals 404 for the transmit antenna array 206 based on the determined RE specific precoding matrices and symbols 403 to be transmitted. The generating of the transmit antenna specific output signals 404 may further comprise applying power normalization.

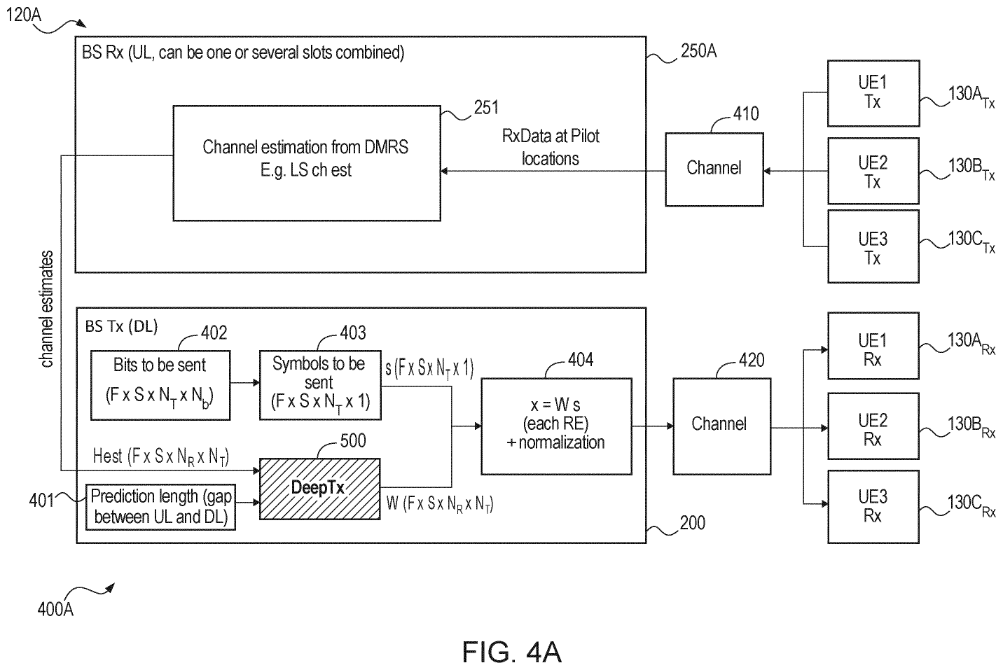

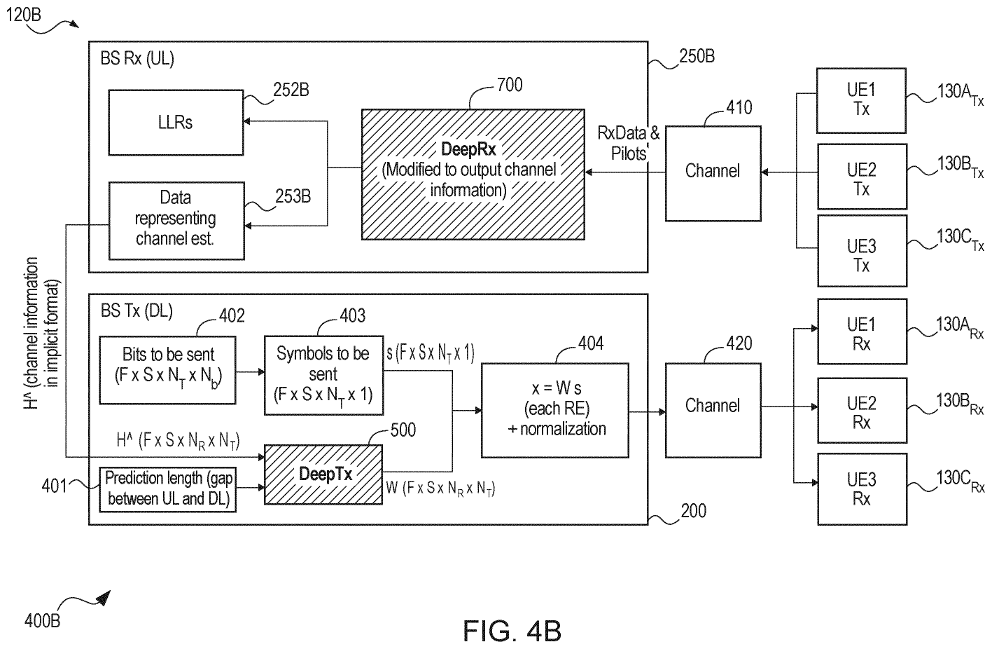

The UL channel 410 information may comprise UL channel 410 estimate information provided by a channel estimator 251. Diagram 400A of FIG. 4A shows an example embodiment of this.

The example embodiment of FIG. 4A may use, e.g., least square (LS) based channel estimation. The NN 500 may be trained and evaluated using the performance (e.g., linear minimum mean square error (LMMSE) receiver output) of the client devices 130A, 130B, 130C (separated to transmit (Tx) and receive (Rx) sides for clarity in FIGS. 4A and 4B).

In FIGS. 4A, 4B, 5, 6 and 7, F represents the number of subcarriers, S represents the number of symbols in a slot, N_{R} represents the number of antennas in the base station 120A, 120B, N_{T} represents the number of MIMO layers, and N_{b} represents the number of bits per symbol.

The example embodiment of FIG. 4A may implement, e.g., the following operations:
1A. During a UL slot, the radio receiver device 250A may feed received data (RxData) corresponding to pilot locations to the LS channel estimator 251 which may form a channel estimate Hₑₛₜ. This may be interpolated to cover all resource elements (REs).
2A. The Hₑₛₜ may be transferred to the radio transmitter device 200.
3A. The radio transmitter device 200 may process the bits 402 to be transmitted and form symbols sᵢⱼ 403 for each RE (a vector of N_{T} elements). The indices i and j cover the data-carrying REs.
4A. The Hₑₛₜ and a prediction length (e.g., the number of time slots between UL and DL) 401 may be fed to the NN 500 to form precoding matrices Wᵢⱼ for each RE.
5A. The radio transmitter device 200 may compute precoded symbols 404 as xᵢⱼ=Wᵢⱼsᵢⱼ,
6A. The radio transmitter device 200 may further apply power normalization: scale x as

$${x}_{transmitted} = a \frac{x}{{‖ x ‖}_{L 2}}$$

in which a is a constant which scales the TX signal x to the desired transmit power. Other normalizations may also be possible, such as normalizing with a standard deviation of the symbols x instead of the above used L2-norm. Herein, L2-norm refers to a method to compute the length of a vector in Euclidean space.

Herein, the subscript ij refers to a RE (i=1 . . . F, j=1 . . . S) and the subscript r refers to the index of the antenna. The complete precoded signal x may be viewed as an F×S×N_{R} array and xᵢⱼ is a vector with N_{R} elements.

At least one of the depthwise separable convolutions may comprise a two-dimensional (2D) depthwise separable 3×3 convolution.

The NN 500 may further comprise a multiplicative layer between two ResNet blocks. Such a multiplicative layer may help the NN 500 to approximate multiplications between inputs (multiplications may be involved, for example, in computations of a ZF solution).

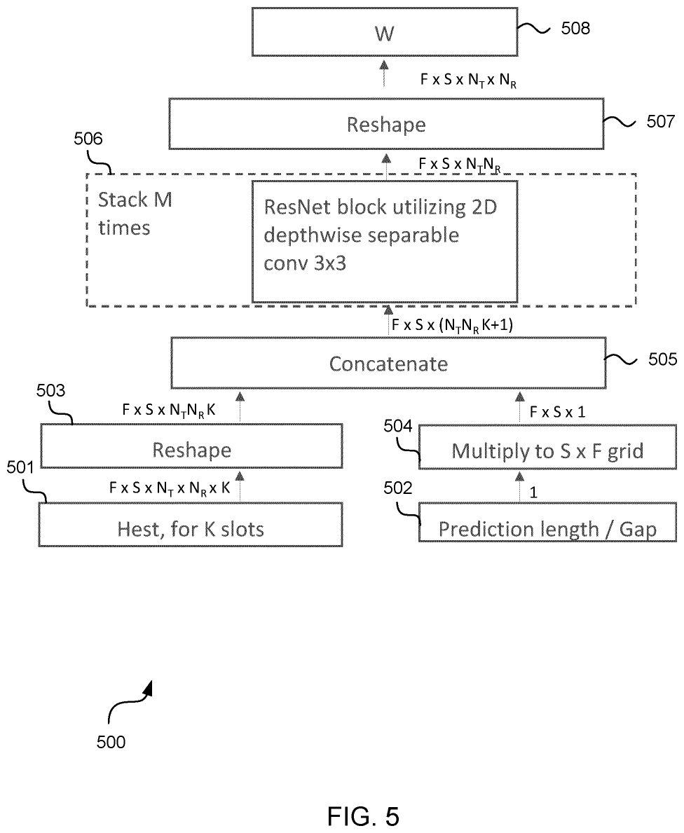

FIG. 5 shows an example embodiment of the subject matter described herein illustrating the NN 500 applied by the radio transmitter device 200. The example embodiment of the NN 500 of FIG. 5 may comprise a block 501 representing the Hₑₛₜ described above in connection with FIG. 4A, and a block 502 representing the prediction length 401 also Hₑₛₜ described above in connection with FIG. 4A. The example embodiment of the NN 500 of FIG. 5 may further comprise a block 503 representing a reshape function, a block 504 representing a multiply function, and a block 505 representing a concatenate function. The example embodiment of the NN 500 of FIG. 5 may further comprise at least one neural network layer 506, at least one of which may comprise a ResNet block. At least some embodiments may comprise M stacked neural network layers/ResNet blocks which may be referred to as a subnetwork. The example embodiment of the NN 500 of FIG. 5 may further comprise a block 507 representing another reshape function. The example embodiment of the NN 500 of FIG. 5 may further comprise a block 508 representing the formed precoding matrices.

The at least one memory 204 and the computer program code may be further configured to, with the at least one processor 202, cause the radio transmitter device 200 to perform training the NN 500 by differentiating through a simulated channel. The simulated channel may be based on a statistically simulated channel, a raytraced channel, and/or a captured channel.

In other words, the training of the radio transmitter device 200 may be carried out by using simulated data which may be generated using a link level simulator. At least in some embodiments, both UL and DL as well as the evolution of the channel between UL and DL may be simulated. Some parts of the link level simulation may be carried out in an online fashion, i.e., during training. At least in some embodiments, the channel may be implemented such that its differentiable with respect to the input. At least in some embodiments, a receiver algorithm implementation may be used for UEs that is differentiable in the same manner.

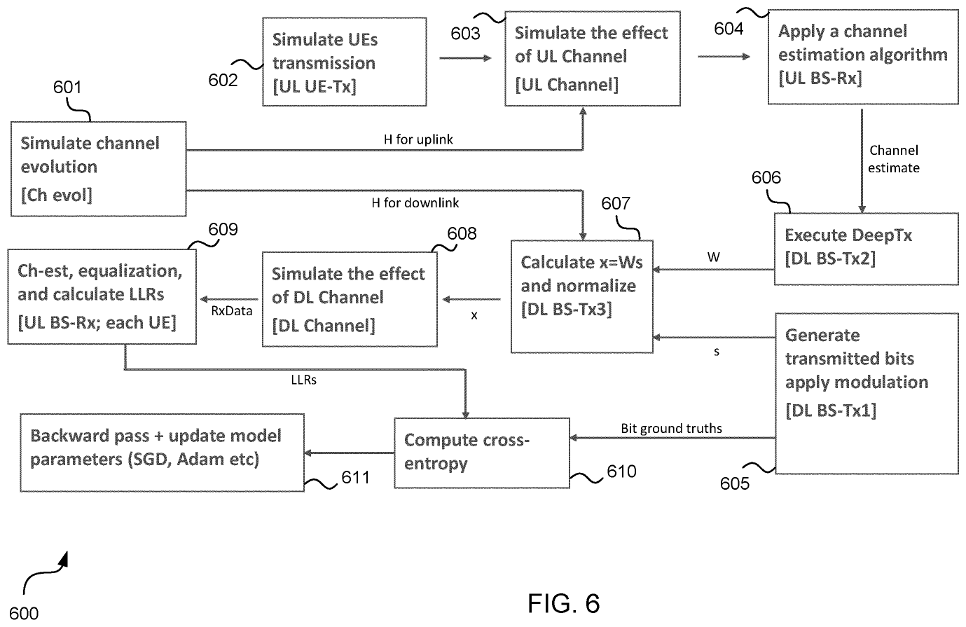

Diagram 600 of FIG. 6 illustrates an example of training of the NN 500 applied by the radio transmitter device 200, in which sample generation and applying the at least one neural network layer 506 (at least one of which may include a ResNet block) in training (a forward pass) may be done using, e.g., the following procedure.
Operation 601 [CH EVOL]: Simulate the evolution of the channel for multiple slots including UL and DL slots. Store information about the channel (taps/channel matrix).
Operation 602 [UL UE-Tx]: Simulate the UEs 130A, 130B, 130C with random parameters: generate transmitted bits (possibly including coding using, e.g., low-density parity-check (LDPC)), apply modulation (e.g., QAM) and form a frequency-time UL RE grid.
Operation 603 [UL Channel]: Evaluate the channel and form a received antenna signal RxData at the base station 120A.
Operation 604 [UL BS-Rx]: Apply a channel estimation algorithm (e.g., LS) to RxData in pilot locations, interpolate over all REs, and save the channel estimate.
Operation 605 [DL BS-Tx1]: Simulate with random parameters: generate transmitted bits (possibly including coding using, e.g., LDPC) and apply modulation to form s.
Operation 606 [DL BS-Tx2]: Pass the UL channel 410 estimate to the NN 500 which outputs W.
Operation 607 [DL BS-Tx3]: Calculate x=Ws and normalize.
Operation 608 [DL Channel]: Evaluate the channel and form a received antenna signal at the UEs 130A, 130B, 130C (RxData).
Operation 609 [UL BS-Rx]: For each UE 130A, 130B, 130C, apply a channel estimation algorithm, equalize the RX signal, and calculate log-likelihood ratios (LLRs) for output bits.
Operation 610: Compute a cross-entropy loss.
Operation 611: Perform a backward pass, and update model parameters.

Operations 601-605 may be performed offline by saving the related variables. Optionally, if use of several UE slots as input data is desirable, operations 602-6044 may be repeated for each slot and the channel estimates combined.

The training of the NN 500 may further comprise applying a loss. The loss may comprise a sum of one or more cross-entropy losses.

For example, the loss function for the training may be specified using bit estimates of the UEs 130A, 130B, 130C in DL, using, e.g., the following cross-entropy loss:

$$CE ( b , \hat{b} ) = - \frac{1}{\# DB} {\sum }_{( i , j ) ∈ D} {\sum }_{l = 0}^{B - 1} ( {b}_{ijl} log {\hat{b}}_{ijl} + ( 1 - {b}_{ijl} ) log ( 1 - {\hat{b}}_{ijl} ) )$$

in which D is the set of indices corresponding to REs carrying data, #D is the number of such REs, B is the number of samples in a sample batch, and \hat{b}ᵢⱼₗ are the predicted bit probabilities defined as \hat{b}ᵢⱼₗ=sigmoid (Lᵢⱼₗ), in which Lᵢⱼₗ is the estimated log-likelihood ratio of the UE receiver algorithm (before possible LDPC decoding).

The training of the NN 500 may further comprise optimizing the loss based on stochastic gradient descent and backpropagation. For example, the related supervised learning task may be solved by optimizing the loss using stochastic gradient descent or its extensions (e.g., Adam optimizer) and back propagation.

At least in some embodiments, a multi-user model may be trained by initializing model weights using a single-user model. At least in some embodiments, training may be performed first using exponential loss, and later a switch to using the cross-entropy loss may be performed (e.g., linearly during the training).

Alternative to the UL channel 410 information comprising UL channel 410 estimate information provided by the channel estimator 251, the UL channel 410 information may instead comprise UL channel 410 estimate information provided by a radio receiver device 250B utilizing an iterative neural network 700 to generate the UL channel 410 estimate information. Diagram 400B of FIG. 4B shows an example embodiment of this.

In the embodiment of FIG. 4B, the NN 500 is arranged in connection with the neural network 700 based radio receiver device 250B or another type of a neural network based receiver.

In the example of FIG. 4B, the neural network 700 is able to output channel information. In this example embodiment, the channel information passing from the neural network 700 to the NN 500 does not need to be in any explicit format (such as the frequency presentation H). Instead, the data format may be learned during the training process.

The example embodiment of FIG. 4B may implement, e.g., the following operations:
1B. During a UL slot, the NN 700 may take the received data (RxData) corresponding to pilot locations and form LLRs for the UL and the channel information H\hat{ }.
2B. The H\hat{ } may be transferred to the radio transmitter device 200.
3B. The radio transmitter device 200 may process the bits 402 to be transmitted and form symbols s (a vector of N_{T} elements) corresponding the used modulation scheme.
4B. The H\hat{ } and the prediction length 401 may be fed to the NN 500 to form precoding matrices Wᵢⱼ.
5B. Precoded symbols may be computed as xᵢⱼ=Wᵢⱼsᵢⱼ,
6B. Power normalization may be applied: scale x as

$${x}_{transmitted} = a \frac{x}{{‖ x ‖}_{L 2}} .$$

Here, operations 2B-6B are similar to operations 2A-6A described above in connection with the example embodiment of FIG. 4A.

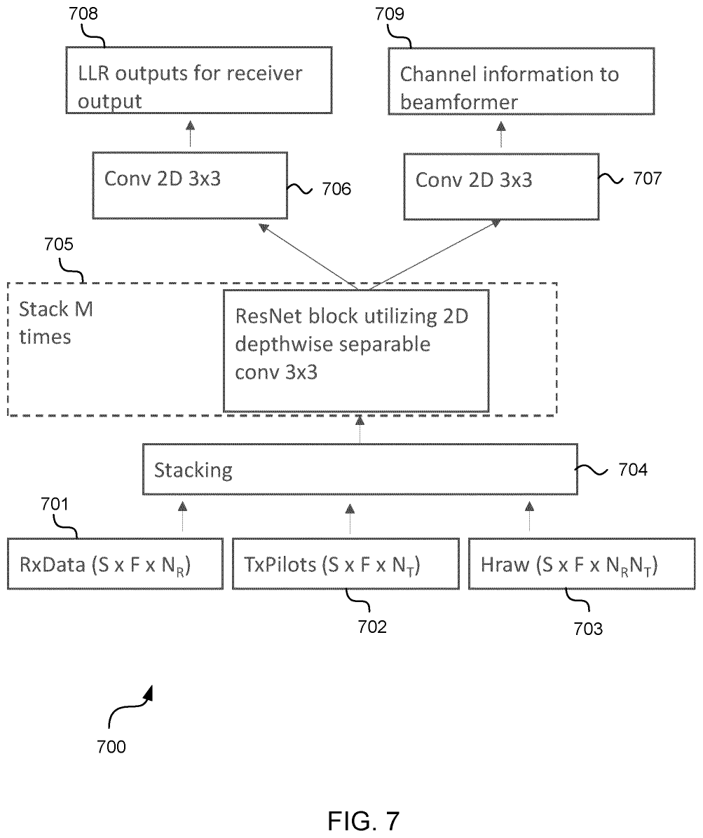

FIG. 7 shows another example embodiment of the subject matter described herein illustrating the NN 700 applied by the radio receiver device 250B. The example embodiment of the NN 700 of FIG. 7 may comprise a block 701 representing received data, a block 702 representing transmit pilots, and a block 703 representing raw channel information. The example embodiment of the NN 700 of FIG. 7 may further comprise a block 704 representing a stacking function. The example embodiment of the NN 700 of FIG. 7 may further comprise at least one neural network layer 705, at least one of which may comprise a ResNet block. At least some embodiments may comprise M stacked neural network layers/ResNet blocks which may be referred to as a subnetwork. The output of the neural network layer 705 may be fed to blocks 706, 707 representing 3×3 two-dimensional convolution (Conv2D) layers, one outputting LLRs 708 and the other forming the channel information 709. At least in some embodiments, the dimension of the channel information may be chosen to be the same as that of the channel estimate.

Training of the example embodiments of FIGS. 4B and 7 may be done using, e.g., the following procedure.
[CH EVOL]: Simulate the evolution of the channel for multiple slots including UL and DL slots. Store information about the channel (taps/channel matrix).
[UL UE-Tx]: Simulate the UEs 130A, 130B, 130C with random parameters: generate transmitted bits (possibly including coding using, e.g., LDPC), apply modulation (e.g., QAM) and form a frequency-time UL RE grid.
[UL Channel]: Evaluate the channel and form a received antenna signal RxData at the base station 120B.
[UL BS-Rx]: Apply the NN 700 to RxData in pilot locations and save LLRs and the channel output.
[DL BS-Tx1]: Simulate the DL with random parameters: generate transmitted bits (possibly including coding using e.g. LDPC) and apply modulation to form s.
[DL BS-Tx2]: Pass the UL channel 410 estimate to the NN 500 to form W.
[DL BS-Tx3]: Calculate x=Ws, and normalize.
[DL Channel]: Evaluate the channel and form a received antenna signal at the UEs 130A, 130B, 130C (RxData).
[UL BS-Rx]: For each UE 130A, 130B, 130C, apply a channel estimation algorithm, equalize the RX signal, and decode bits.

Both the NN 700 and the NN 500 may be trained simultaneously. The loss may be, e.g., a combination of the cross-entropy loss of the NN 700 and the NN 500:

$$L = {CE}_{UL} + α {CE}_{DL}$$

in which α is a constant which may be tuned so that neither the NN 700 nor the NN 500 overperforms the other.

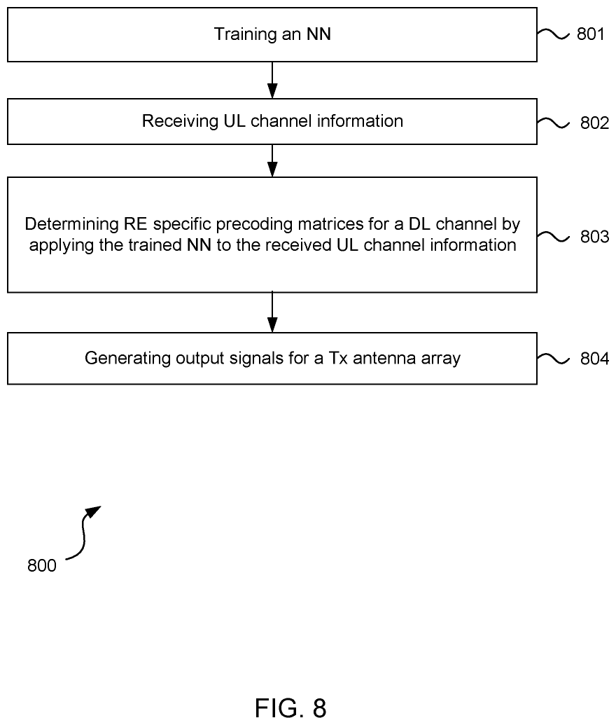

FIG. 8 illustrates an example flow chart of a method 800, in accordance with an example embodiment.

At optional operation 801, the radio transmitter device 200 may perform training of the NN 500 by differentiating through a simulated channel.

At operation 802, the radio transmitter device 200 receives the UL channel 410 information.

At operation 803, the radio transmitter device 200 determines the RE specific precoding matrices for the DL channel 420 based on the received UL channel 410 information. As described in more detail connection with FIG. 2, the determining of the RE specific precoding matrices for the DL channel based on the received UL channel information is performed by applying the NN 500 to the received UL channel 410 information, the NN 500 comprising at least one neural network layer 506 executable to process the received UL channel 410 information to output the RE specific precoding matrices for the DL channel 420.

At operation 804, the radio transmitter device 200 generates the transmit antenna specific output signals for the transmit antenna array 206 based on the determined RE specific precoding matrices and the symbols to be transmitted.

The method 800 may be performed by the radio transmitter device 200 of FIG. 2. The operations 801-804 can, for example, be performed by the at least one processor 202 and the at least one memory 204. Further features of the method 800 directly result from the functionalities and parameters of the radio receiver device 200, and thus are not repeated here. The method 800 can be performed by computer program(s).

At least some of the embodiments described herein may allow a neural network based radio transmitter device that generates a complete precoding matrix based on a channel estimate. At least some of the embodiments described herein may allow a way of jointly training a neural network based radio transmitter device with a neural network based radio receiver device. At least some of the embodiments described herein may allow a way of training a neural network based radio transmitter device by differentiating through a simulated channel, whose underlying channel implementation may be based on statistically simulated, raytraced or captured channels. At least some of the embodiments described herein may allow improved beamforming performance due to: better prediction of future channel, optimal information transfer between a neural network based radio transmitter device and a neural network based radio receiver device, efficient inference using an AI accelerator, and/or easy integration to existing processing in products.

The radio transmitter device 200 may comprise means for performing at least one method described herein. In one example, the means may comprise the at least one processor 202, and the at least one memory 204 including program code configured to, when executed by the at least one processor, cause the radio transmitter device 200 to perform the method.

The functionality described herein can be performed, at least in part, by one or more computer program product components such as software components. According to an embodiment, the radio transmitter device 200 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A radio transmitter device, comprising:
a transmit antenna array comprising at least two transmit antennas;
at least one processor; and
at least one non-transitory memory storing instructions that, when executed with the at least one processor, cause the radio transmitter device to at least perform:
receiving uplink channel information;
determining resource element specific precoding matrices for a downlink channel based on the received uplink channel information; and
generating transmit antenna specific output signals for the transmit antenna array based on the determined resource element specific precoding matrices and symbols to be transmitted,
wherein the determining of the resource element specific precoding matrices for the downlink channel based on the received uplink channel information is performed with applying a neural network to the received uplink channel information, the neural network comprising at least one neural network layer executable to process the received uplink channel information to output the resource element specific precoding matrices for the downlink channel.

2. The radio transmitter device according to claim 1, wherein the neural network comprises at least one of a convolutional neural network, a transformer neural network, or a combination thereof.

3. The radio transmitter device according to claim 1, wherein the neural network utilizes residual connections.

4. The radio transmitter device according to claim 2, wherein at least one of the at least one neural network layer layers utilizes depthwise separable convolution.

5. The radio transmitter device according to claim 1, wherein the instructions, when executed with the at least one processor, cause the radio transmitter device to perform the determining of the resource element specific precoding matrices further with applying a zero-forcing transformation or an approximation of the zero-forcing transformation to the output of the neural network.

6. The radio transmitter device according to claim 1, wherein the instructions, when executed with the at least one processor, cause the radio transmitter device to perform the determining of the resource element specific precoding matrices further based on a prediction length.

7. The radio transmitter device according to claim 1, wherein the uplink channel information comprises uplink channel estimate information provided with a channel estimator.

8. The radio transmitter device according to claim 1, wherein the uplink channel information comprises uplink channel estimate information provided with a radio receiver device utilizing an iterative neural network to generate the uplink channel estimate information.

9. The radio transmitter device according to claim 1, wherein the instructions, when executed with the at least one processor, cause the radio transmitter device to perform training the by neural network with differentiating through a simulated channel.

10. The radio transmitter device according to claim 9, wherein the simulated channel is based on at least one of a statistically simulated channel, a raytraced channel, or a captured channel.

11. The radio transmitter device according to claim 9, wherein the instructions, when executed with the at least one processor, train the neural network with applying a loss.

12. The radio transmitter device according to claim 11, wherein the loss comprises a sum of one or more cross-entropy losses.

13. The radio transmitter device according to claim 11, wherein the instructions, when executed with the at least one processor, train the neural network with optimizing the loss based on stochastic gradient descent and backpropagation.

14. The radio transmitter device according to claim 1, wherein the radio transmitter device comprises a time division duplexing capable radio transmitter device.

15. The radio transmitter device according to claim 1, wherein the radio transmitter device comprises a multiple-input and multiple-output capable radio transmitter device.

16. A method, comprising:
receiving, at a radio transmitter device, uplink channel information;
determining, with the radio transmitter device, resource element specific precoding matrices for a downlink channel based on the received uplink channel information; and
generating, with the radio transmitter device, transmit antenna specific output signals for the transmit antenna array based on the determined resource element specific precoding matrices and symbols to be transmitted;
wherein the determining of the resource element specific precoding matrices for the downlink channel based on the received uplink channel information is performed with applying a neural network to the received uplink channel information, the neural network comprising at least one neural network layer executable to process the received uplink channel information to output the resource element specific precoding matrices for the downlink channel.

17. A non-transitory program storage device readable with an apparatus, tangibly embodying a program of instructions executable with the apparatus to perform at least the following:
receiving uplink channel information;
determining resource element specific precoding matrices for a downlink channel based on the received uplink channel information; and
generating transmit antenna specific output signals for the transmit antenna array based on the determined resource element specific precoding matrices and symbols to be transmitted;
wherein the determining of the resource element specific precoding matrices for the downlink channel based on the received uplink channel information is performed with applying a neural network to the received uplink channel information, the neural network comprising at least one neural network layer executable to process the received uplink channel information to output the resource element specific precoding matrices for the downlink channel.
